(19) United States
(12) Patent Application Publication
(10) Pub. No.: US 2010/0248069 A1
(43) Pub. Date: Sep. 30, 2010

(54) FUEL CELL

(75) Inventors: Hiroki KABUMOTO, Saitama-shi (JP); Takashi Yasuo, Kobe-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/731,879

(22) Filed: Mar. 25, 2010

(30) Foreign Application Priority Data
Mar. 25, 2009 (JP) 2009-074927

(51) Int. Cl. H01M 8/10; H01M 8/24

(52) U.S. Cl. 429/465

(57) ABSTRACT

A fuel cell includes a membrane electrode assembly. The membrane electrode assembly has an electrolyte membrane, cathode catalyst layers, and anode catalyst layers disposed counter to the cathode catalyst layers with the electrolyte membrane disposed between the cathode catalyst layers and the anode catalyst layers. Cathode-side insulating layers, which are water-repellent, are provided between the adjacent cathode catalyst layers. The surface of the cathode-side insulating layer on the opposite side of the electrolyte membrane is protruded relative to the surface of the adjacent cathode catalyst layers. Anode-side insulating layers, which are water-repellent, are provided between the adjacent anode catalyst layers. The surface of the anode-side insulating layer on the opposite side of the electrolyte membrane is protruded relative to the surface of the adjacent anode catalyst layers.

### CROSS-REFERENCE TO RELATED APPLICATIONS

This application is based upon and claims the benefit of priority from the prior Japanese Patent Applications No. 2009-074927, filed on Mar. 25, 2009, the entire contents of which are incorporated herein by reference.

### BACKGROUND OF THE INVENTION

1. Field of the Invention

The present invention relates to a fuel cell. More particularly, the invention relates to a fuel cell with its cells disposed in a planar arrangement.

2. Description of the Related Art

A fuel cell is a device that generates electricity from hydrogen and oxygen so as to obtain highly efficient power generation. A principal feature of a fuel cell is its capacity for direct power generation which does not undergo a stage of thermal energy or kinetic energy as in conventional power generation. This presents such advantages as high power generation efficiency despite the small scale setup, reduced emission of nitrogen compounds and the like, and environmental friendliness on account of minimal noise or vibration. A fuel cell is capable of efficiently utilizing chemical energy in its fuel and, as such, environmentally friendly. Fuel cells are therefore envisaged as an energy supply system for the twenty-first century and have gained attention as a promising power generation system that can be used in a variety of applications including space applications, automobiles, mobile devices, and large and small scale power generation. Serious technical efforts are being made to develop practical fuel cells.

In particular, polymer electrolyte fuel cells feature lower operating temperature and higher output density than the other types of fuel cells. In recent years, therefore, the polymer electrolyte fuel cells have been emerging as a promising power source for mobile devices such as cell phones, notebook-size personal computers, PDAs, MP3 players, digital cameras, electronic dictionaries or electronic books. Well known as the polymer electrolyte fuel cells for mobile devices are planar fuel cells, which have a plurality of single cells arranged in a plane. And as a fuel to be used for this type of fuel cells, hydrogen stored in a hydrogen storage alloy or a hydrogen cylinder, as well as methanol, is the subject of continuing investigations.

In the conventional planar fuel cells, if the water generated by the reaction of hydrogen and oxygen and the water (e.g., tap water), used in daily life, which is infiltrated from the outside of a fuel cell stay on across adjacent single cells, the adjacent single cells may be short-circuited.

The following factors (1) to (3) are attributed to the reason why the generated water becomes conductive.

(1) Carbon dioxide is dissolved into the generated water.

(2) Any of members or materials constituting the fuel cell is eluted into the generated water.

(3) Impurities adhered to the surfaces of any members or materials constituting the fuel cell are mixed into the generated water.

### SUMMARY OF THE INVENTION

The present invention has been made in view of the foregoing problems, and a purpose thereof is to provide a technology by which to reduce the short-circuiting occurring between adjacent singles cells in a planar fuel cell.

A fuel cell according to one embodiment of the present invention comprises: a plurality of single cells, disposed in a planar arrangement, each single cell including an electrolyte membrane containing an ionomer, an anode provided on one face of the electrolyte membrane and a cathode provided on the other face of the electrolyte membrane; and an insulating layer provided between adjacent electrodes in at least one of adjacent anodes and adjacent cathodes, for the each of adjacent single cells in the plurality of single cells, wherein the surface, of said insulating layer, opposite to the electrolyte membrane is protruded relative to the surface of the insulating layer on either face of the electrolyte membrane.

By employing the above-described embodiment, the insulating layer provided between adjacent electrodes (between adjacent anodes and/or between adjacent cathodes) in a protruded manner suppresses the water from staying on across between the adjacent electrodes. As a result, the short-circuiting occurring between the adjacent electrodes is suppressed and consequently the operation stability of the fuel cell can be improved.

In the above-described embodiment, the insulating layer may be water-repellent. The fuel cell may further comprise an electrical connecting member, disposed along the adjacent electrodes, configured to connect adjacent single cells in series, wherein the insulating layer may be provided on the both sides of the electrical connecting member, and wherein the insulating layer on one side of the electrical connecting member may be formed on a discontinuous region such that an electrode disposed on the one side of the electrical connecting member is connected to the electrical member.

The fuel cell may further comprise a plate-like member which forms a reaction gas chamber facing the electrodes, wherein at least part of surface, of said insulating layer, opposite to the electrolyte membrane may be in contact with the plate-like member. In such a case, the fuel cell may further comprise an electrical connecting member, disposed along the adjacent electrodes, configured to connect adjacent single cells in series, wherein the insulating layer may be provided on the both sides of the electrical connecting member, and wherein the insulating layer on one side of the electrical connecting member may be formed on a discontinuous region such that an electrode disposed on the one side of the electrical connecting member is connected to the electrical member, and the insulating layer formed on the discontinuous region may be in contact with the plate-like member.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is an exploded perspective view of a fuel cell according to a first embodiment of the present invention;

FIG. 2 is a cross-sectional view taken along the line A-A of FIG. 1;

FIG. 3 is an exploded perspective view of a fuel cell according to a second embodiment of the present invention;

FIG. 4 is a cross-sectional view taken along the line A-A of FIG. 3;

FIG. 5 is a cross-sectional view taken along the line B-B of FIG. 3;

FIG. 6 is a cross-sectional view taken along the line C-C of FIG. 3;

FIG. 7 is an exploded perspective view of a fuel cell according to a third embodiment of the present invention;

FIG. 8 is a cross-sectional view taken along the line A-A of FIG. 7;

FIG. 9 is a cross-sectional view taken along the line B-B of FIG. 7;

FIG. 10 is a cross-sectional view taken along the line C-C of FIG. 7;

FIG. 11 is a cross-sectional view showing a structure of a fuel cell according to a first modification;

FIG. 12A is a cross-sectional perspective view showing major parts that constitute a fuel cell according to a second modification;

FIG. 12B is a cross-sectional perspective view showing major parts that constitute a fuel cell according to a third modification;

FIG. 13A is a cross-sectional perspective view showing major parts that constitute a fuel cell of Comparative Example 1; and

FIG. 13B is a cross-sectional perspective view showing major parts that constitute a fuel cell of Comparative Example 2.

### DETAILED DESCRIPTION OF THE INVENTION

The invention will now be described by reference to the preferred embodiments. This does not intend to limit the scope of the present invention, but to exemplify the invention.

Note that in all the Figures, the same reference numbers are used to indicate the same or similar component elements and the description thereof is omitted as appropriate.

### First Embodiment

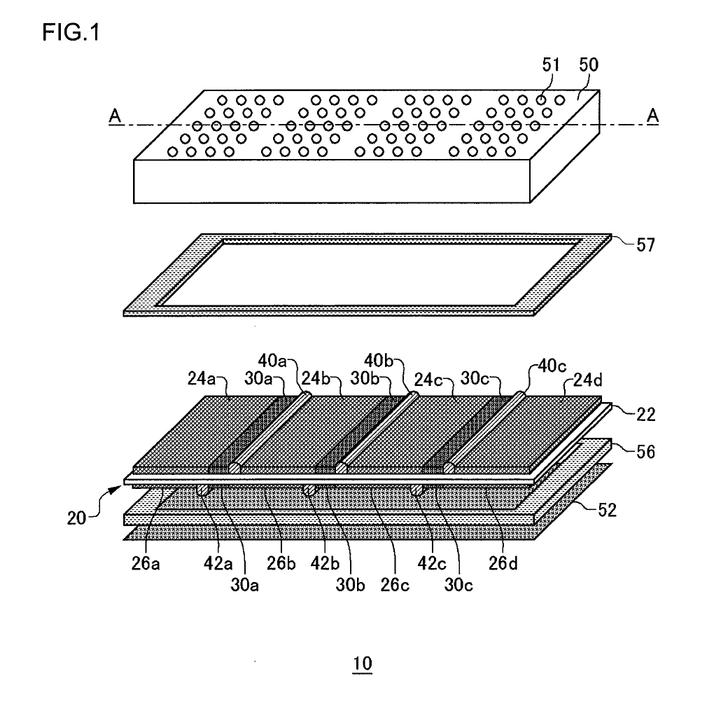

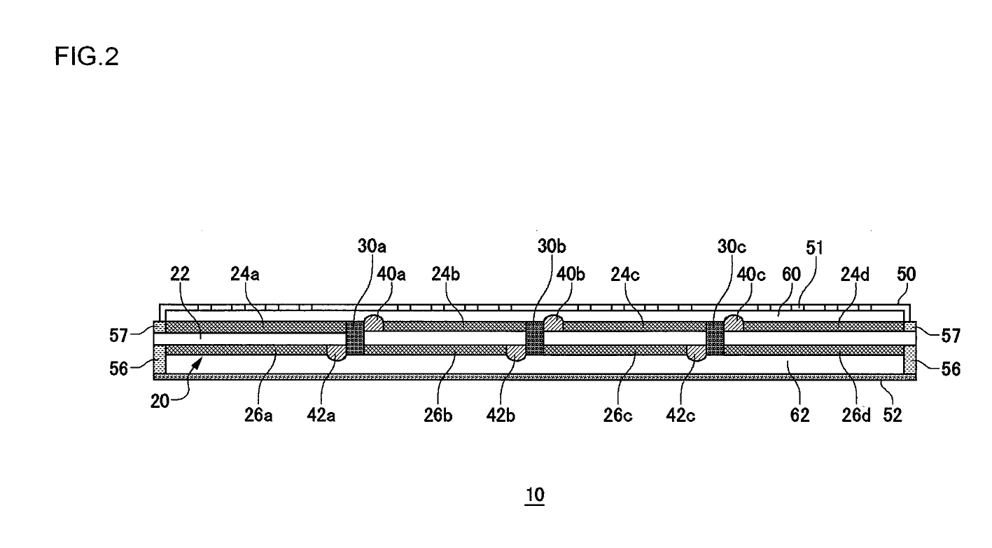

FIG. 1 is an exploded perspective view of a fuel cell according to a first embodiment of the present invention. FIG. 2 is a cross-sectional view thereof taken along the line A-A of FIG. 1. Referring to FIG. 1 and FIG. 2, a fuel cell 10 includes a membrane electrode assembly (MEA) 20, a cathode housing 50 and an anode housing 52.

The membrane electrode assembly 20 includes an electrolyte membrane 22, cathode catalyst layers 24a to 24d, and anode catalyst layers 26a to 26d disposed counter respectively to the cathode catalyst layers 24a to 24d by way of the electrolyte membrane 22. Hereinafter, the cathode catalyst layers 24a to 24d are generically or indistinctively referred to as “cathode catalyst layer 24” also on some occasions. Similarly, the anode catalyst layers 26a to 26d are hereinafter generically or indistinctively referred to as “anode catalyst layer 26” also on some occasions. Note that the cathode catalyst layer 24 and the anode catalyst layer 26 are each an example of “electrode” in the fuel cell 10.

The electrolyte membrane 22, which may show excellent ion conductivity in a moist or humidified condition, functions as an ion-exchange membrane for the transfer of protons between the cathode catalyst layer 24 and the anode catalyst layer 26. The electrolyte membrane 22 is formed of a solid polymer material such as a fluorine-containing polymer or a nonfluorine polymer. The material that can be used is, for instance, a sulfonic acid type perfluorocarbon polymer, a polysulfone resin, a perfluorocarbon polymer having a phosphonic acid group or a carboxylic acid group, or the like. An example of the sulfonic acid type perfluorocarbon polymer is a Nafion ionomer dispersion (made by DuPont: registered trademark) 112. Also, an example of the nonfluorine polymer is a sulfonated aromatic polyether ether ketone, polysulfone or the like. The thickness of the electrolyte membrane 22 may be about 10 to 200 μm, for instance.

The cathode catalyst layers 24a to 24d are formed on one face of the electrolyte membrane 22 in such a manner as to be slightly apart from each other. Air is supplied to the cathode catalyst layers 24 as oxidant. The anode catalyst layers 26a to 26d are formed on the other face of the electrolyte membrane 22 in such a manner as to be slightly apart from each other. Hydrogen is supplied to the anode catalyst layers 26a to 26d as fuel gas. A single cell is structured by a pair of anode catalyst layer 24 and cathode catalyst layer 26 with the electrolyte membrane 22 held between the anode catalyst layer 24 and the cathode catalyst layer 26. Each single cell generates electric power through an electrochemical reaction between hydrogen (e.g. hydrogen) and oxygen in the air.

The cathode catalyst layer 24 and the anode catalyst layer 26 are provided with ion-exchange material and catalyst particles or carbon particles as the case may be.

The ion-exchange material provided in the cathode catalyst layer 24 and the anode catalyst layer 26 may be used to promote adhesion between the catalyst particles and the electrolyte membrane 22. This ion-exchange material may also play a role of transferring protons between the catalyst particles and the electrolyte membrane 22. The ion-exchange material may be formed of a polymer material similar to that of the electrolyte membrane 22. A catalyst metal may be a single element or an alloy of two or more elements selected from among Sc, Y, Ti, Zr, V, Nb, Fe, Co, Ni, Ru, Rh, Pd, Pt, Os, Ir, lanthanide series element, and actinide series element. Furnace black, acetylene black, ketjen black, carbon nanotube or the like may be used as the carbon particle when a catalyst is to be supported. The thickness of the cathode catalyst layer 24 and the anode catalyst layer 26 may be from about 10 to 40 μm, for instance.

In this manner, the fuel cell 10 according to the present embodiment comprises a plurality of single cells, in a planar arrangement, which are composed of the respective pairs of the cathode catalyst layers 24a to 24d and the anode catalyst layers 26a to 26d. Interconnectors (electric connecting members) 30a to 30c that penetrate the electrolyte membrane 22 are provided between adjacent single cells. Hereinafter, the interconnectors 30a to 30c are generically or indistinctively referred to as “interconnector 30” also on some occasions. Specifically, the interconnector 30a connects electrically the cathode catalyst layer 24a to the anode catalyst layer 26b. Also, the interconnector 30b connects electrically the cathode catalyst layer 24b to the anode catalyst layer 26c. Also, the interconnector 30c connects electrically the cathode catalyst layer 24c to the anode catalyst layer 26d. Thereby, the adjacent single cells are connected in series with one another. Examples of a material to induce conductivity of the interconnectors 30a to 30c include a carbon-based material, such as carbon fiber, graphite sheet, carbon paper or carbon power, and a metallic material, such as platinum, gold, stainless steel, titanium or nickel. The width of the interconnector 30 may be about 30 to 300 μm, for instance.

In the fuel cell according to the present embodiment, cathode-side insulating layers 40a to 40c are provided between adjacent cathode catalyst layers 24. Hereinafter, the cathode-side insulating layers 40a to 40c are generically or indistinctively referred to as “cathode-side insulating layer 40” also on some occasions. More specifically, the cathode-side insulating layer 40a is provided on the electrolyte membrane 22 disposed between the interconnector 30a and the cathode catalyst layer 24b. The cathode-side insulating layer 40b is provided on the electrolyte membrane 22 disposed between the interconnector 30b and the cathode catalyst layer 24c. The cathode-side insulating layer 40c is provided on the electrolyte membrane 22 disposed between the interconnector 30c and the cathode catalyst layer 24d.

The surface of the cathode-side insulating layer 40 opposite to the electrolyte membrane 22 is protruded relative to the surface of adjacent cathode catalyst layers 24. In other words, the thickness of the cathode-side insulating layer 40 is greater than that of adjacent cathode catalyst layers 24. Typically, the height of a protruded cathode-side insulating layer 40 is greater than or equal to 1.1 times the thickness of the cathode catalyst layer 24 or greater than the thickness thereof by 4 μm or more. The cathode-side insulating layer 40 is preferably is water-repellent. Here, the water repellency is defined using an contact angle θ of waterdrop on solid surface. In general, it is water-repellent (hydrophobic) when 0 is 90 degrees or above; it is highly water-repellent when 0 is in the range of 110 to 140 degrees; and it is extremely water-repellent when 0 is 140 degrees or above. The water-repellent material used for the cathode-side insulating layer 40 may be a fluororesin (contact angle: 100 to 120 degrees), for instance. The material used as the fluororesin may be polytetrafluoroethylene (PTFE), tetrafluoroethylene-perfluoroalkylvinylether copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE), polychlorotrifluoroethylene-ethylene copolymer (E/CTFE), polyvinyl fluoride fluorovinyl (PVF), perfluoro cyclic polymer or the like.

The cathode-side insulating layer 40 may be formed in such a manner that, for example, a softened fluororesin is coated on the electrolyte membrane 22 exposed between the interconnector 30 and the cathode catalyst layer 24, by the use of syringe-like nozzles.

On the other hand, anode-side insulating layers 42a to 42c are provided between adjacent anode catalyst layers 26. Hereinafter, the anode-side insulating layers 42a to 42c are generically or indistinctively referred to as “anode-side insulating layer 42” also on some occasions. More specifically, the anode-side insulating layer 42a is provided on the electrolyte membrane 22 disposed between the interconnector 30a and the anode catalyst layer 26a. The anode-side insulating layer 42b is provided on the electrolyte membrane 22 disposed between the interconnector 30b and the anode catalyst layer 26b. The anode-side insulating layer 42c is provided on the electrolyte membrane 22 disposed between the interconnector 30c and the anode catalyst layer 26c.

The surface of the anode-side insulating layer 42 opposite to the electrolyte membrane 22 is protruded relative to the surface of adjacent anode catalyst layers 24. In other words, the thickness of the anode-side insulating layer 42 is greater than that of adjacent anode catalyst layers 26. Typically, the height of a protruded cathode-side insulating layer 42 is greater than or equal to 1.1 times the thickness of the anode catalyst layer 26 or greater than the thickness thereof by 4 μm or more. The cathode-side insulating layer 40 is preferably is water-repellent. The water-repellent material used for the anode-side insulating layer 42 may be fluororesin (contact angle: 100 to 120 degrees), for instance. Specific examples for the fluororesin are the same as those described for the cathode-side insulating layer 40.

The anode-side insulating layer 42 may be formed in such a manner that, for example, a softened fluororesin is coated on the electrolyte membrane 22 exposed between the interconnector 30 and the anode catalyst layer 26, by the use of syringe-like nozzles.

The cathode housing 50, placed counter to the cathode catalyst layer 24, is a plate-like member. The cathode housing 50 is provided with air inlets 51 for feeding air from outside. An air chamber 60 where the air flows is formed between the cathode housing 50 and the cathode catalyst layer 24.

The anode housing 52, placed counter to the anode catalyst layer 26, is a plate-like member. A fuel gas chamber 62 for storing the fuel is formed between the anode housing 52 and the anode catalyst layer 26. Note that if a fuel supply port (not shown) is formed in the anode housing 52, fuel can be supplied as needed from a fuel cartridge or the like.

The material used for the cathode housing 50 and the anode housing 52 may be a commonly-used plastic resin such as phenol resin, vinyl resin, polyethylene resin, polypropylene resin, polystyrene resin, urea resin or fluororesin.

Gaskets 56 are provided between outer peripheries of the electrolyte membrane 22 and the cathode housing 50. Provision of the gaskets 56 enhances the sealing performance of the fuel gas chamber 62 and therefore the leakage of the fuel is prevented.

Gaskets 57 are provided between outer peripheries of the electrolyte membrane 22 and the cathode housing 50. Provision of the gaskets 57 enhances the sealing performance of the air chamber 60.

According to the above-described fuel cell 10, the cathode-side insulating layer 40 is provided in a protruded manner between the adjacent cathode catalyst layers 24, namely, between adjacent cathode-side electrodes. Thus, this structure suppresses the water from staying across between the adjacent cathode catalyst layers 24 (i.e., between one single-cell cathode catalyst layer 24 and an interconnector 30 connected to the other single-cell cathode catalyst layer 24, in the present embodiment). As a result, the short-circuiting occurring between the adjacent cathode catalyst layers 24 is suppressed and consequently the operation stability of the fuel cell can be improved. Also, since the cathode-side insulating layer 40 is water-repellent, the water is repelled from the surface of the cathode-side insulating layer 40, thereby making the short-circuiting between the adjacent cathode catalyst layers 24 much less likely to occur. As a result, the operation stability or output stability of the fuel cell 10 can be improved.

Similarly, the anode-side insulating layer 42 is provided in a protruded manner between the adjacent anode catalyst layers 26, namely, between adjacent anode-side electrodes. Thus, this structure suppresses the water from staying across between the adjacent anode catalyst layers 26 (i.e., between one single-cell anode catalyst layer 26 and an interconnector 30 connected to the other single-cell anode catalyst layer 26, in the present embodiment). As a result, the short-circuiting occurring between the adjacent anode catalyst layers 26 is suppressed and consequently the operation stability of the fuel cell can be improved. Also, since the cathode-side insulating layer 42 is water-repellent, the water is repelled from the surface of the anode-side insulating layer 42, thereby making the short-circuiting between the adjacent anode catalyst layers 26 much less likely to occur. As a result, the operation stability or output stability of the fuel cell 10 can be improved.

### Second Embodiment

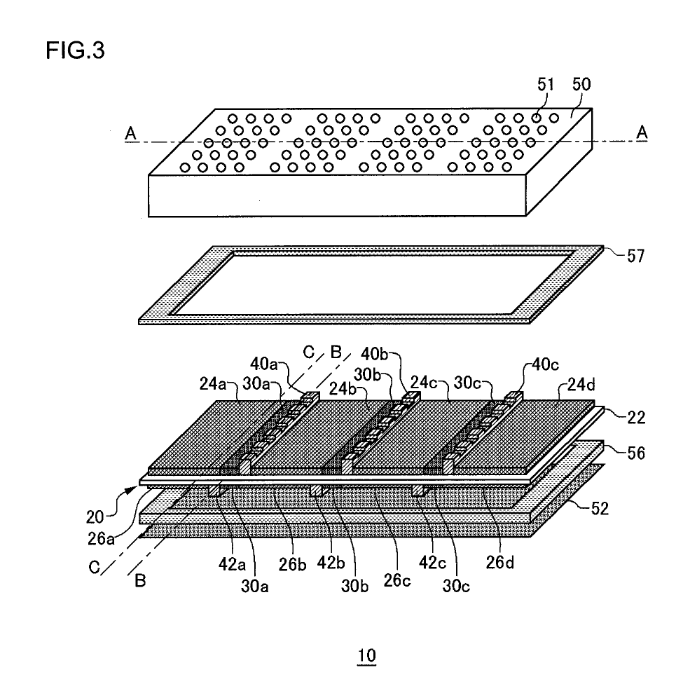

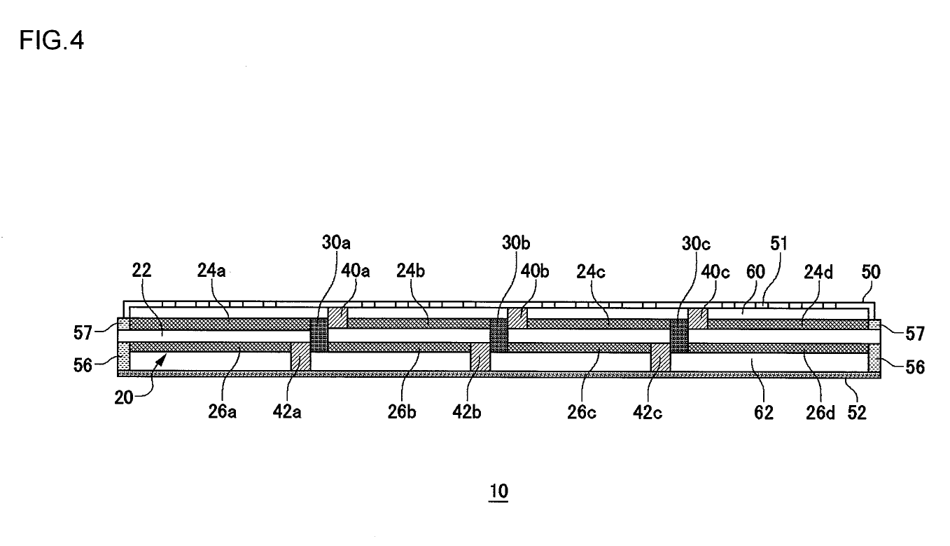

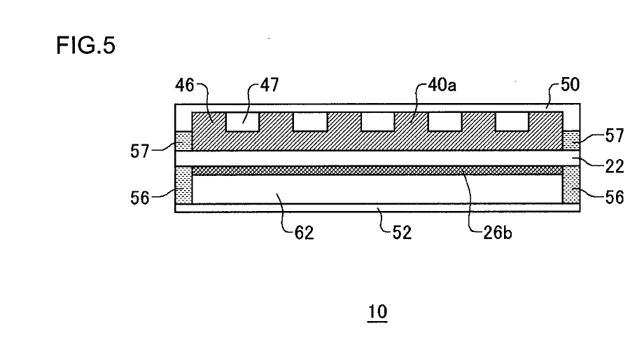

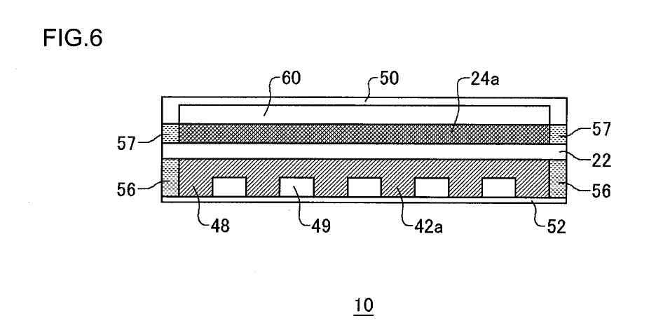

FIG. 3 is an exploded perspective view of a fuel cell according to a second embodiment of the present invention. FIG. 4 is a cross-sectional view taken along the line A-A of FIG. 3. FIG. 5 is a cross-sectional view taken along the line B-B of FIG. 3. FIG. 6 is a cross-sectional view taken along the line C-C of FIG. 3. The basic structure of a fuel cell 10 according to the second embodiment is the same as the structure of the first embodiment. A description is given hereinbelow of the fuel cell 10 according to the second embodiment centering around a structure different from that of the first embodiment.

In the second embodiment, the cathode-side insulating layer 40 is partially in contact with the inner surface of the cathode housing 50. More specifically, in the cathode-side insulating layer 40, a plurality of protrusions 46 having such a height that the top thereof reaches the inner surface of the cathode housing 50 are provided in such a manner that the plurality of protrusions 46 are spaced apart from each other, as illustrated in FIG. 5. Openings 47 are formed between the adjacent protrusions 46, and the air chambers 60 corresponding to the adjacent single cells communicate with each other through the openings 47.

On the other hand, the anode-side insulating layer 42 is partially in contact with the inner surface of the cathode housing 52. More specifically, in the anode-side insulating layer 42, a plurality of protrusions 48 having such a height that the top thereof reaches the inner surface of the cathode housing 50 are provided slightly apart from each other, as illustrated in FIG. 6. Openings 49 are formed between the adjacent protrusions 48, and the fuel gas chambers 62 corresponding to the adjacent single cells communicate with each other through the openings 49.

According to the above-described fuel cell 10, the diffusivity of air in the air chamber 60 is assured and at the same time the protrusions 46 disposed in contact with the cathode housing 50 physically block and prevent the water from staying on between the adjacent single-cell cathodes. As a result, the operation stability or output stability of the fuel cell 10 can be further improved.

Also, the diffusivity of fuel in the fuel gas chamber 62 is assured and at the same time the protrusions 48 disposed in contact with the anode housing 52 physically block and prevent the water from staying on between the adjacent single-cell anodes. As a result, the operation stability or output stability of the fuel cell 10 can be further improved.

No such protrusions 46 and 48 are provided in Comparative Example 1 to be described later. Thus, the above-described advantageous effect of blocking the water by provision of the above-described protrusions 46 and 48 is much less likely to be realized in Comparative Example 1.

### Third Embodiment

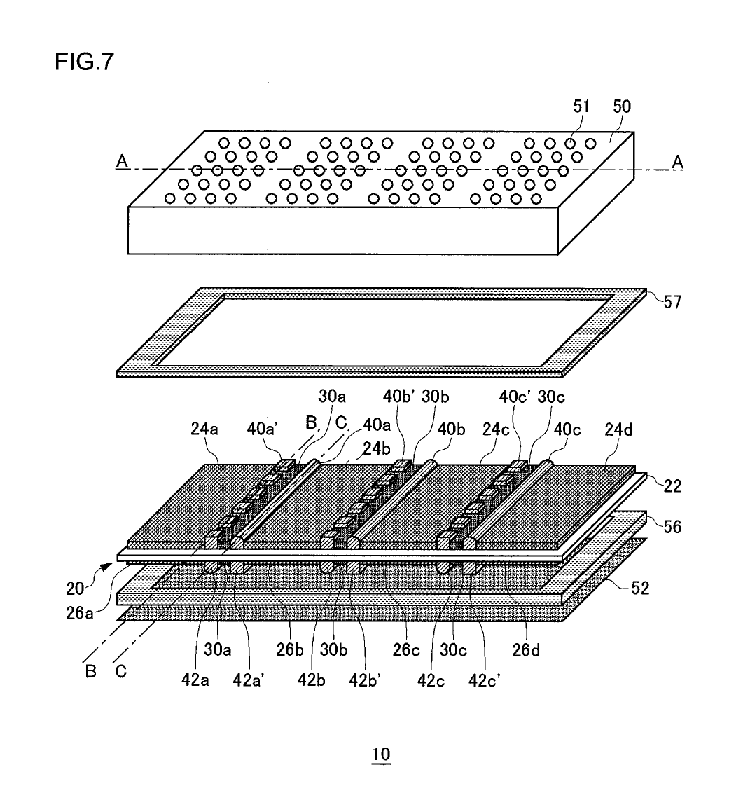

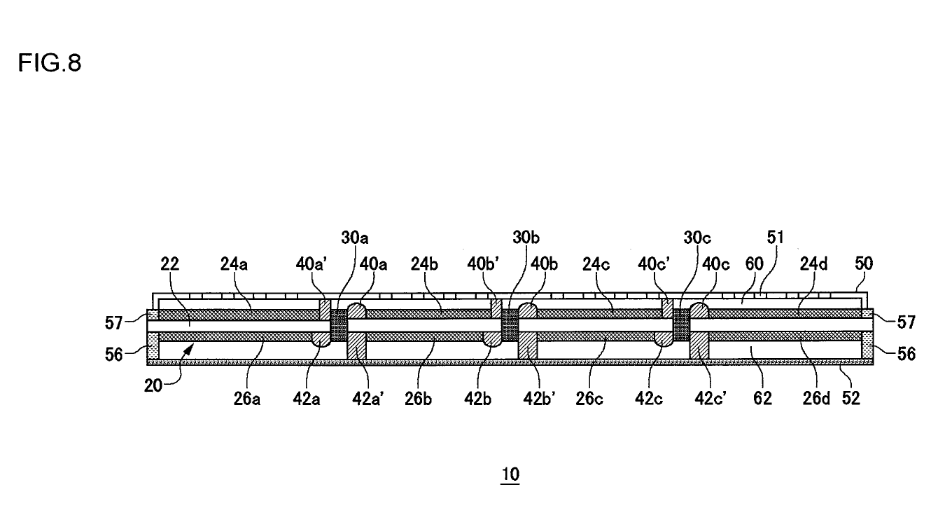

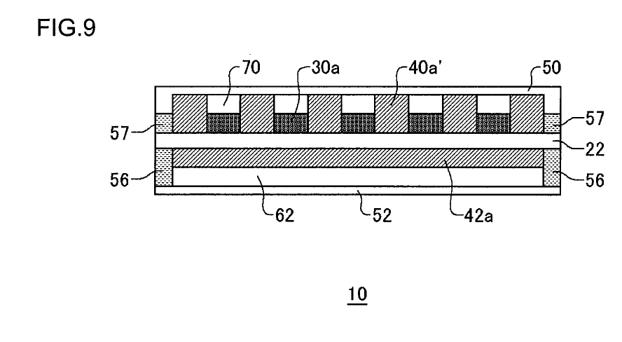

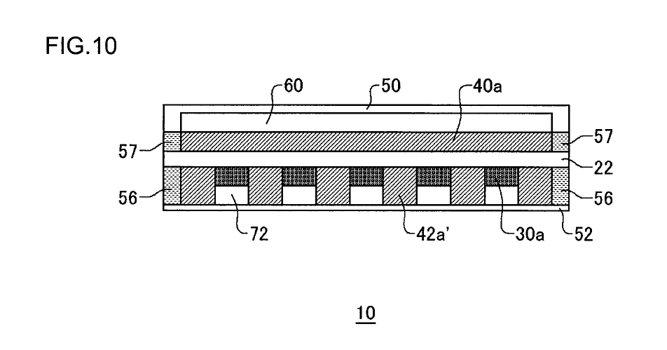

FIG. 7 is an exploded perspective view of a fuel cell according to a third embodiment of the present invention. FIG. 8 is a cross-sectional view taken along the line A-A of FIG. 7. FIG. 9 is a cross-sectional view taken along the line B-B of FIG. 7. FIG. 10 is a cross-sectional view taken along the line C-C of FIG. 7. The basic structure of a fuel cell 10 according to the third embodiment is the same as the structure of the first embodiment. A description is given hereinbelow of the fuel cell 10 according to the third embodiment centering around a structure different from that of the first embodiment.

In the third embodiment, cathode-side insulating layers 40 are provided on the both sides of the connector 30. The cathode catalyst layer 24 on one side of the interconnector 30 is formed on a discontinuous region such that the cathode catalyst layer 24 disposed on the one side of the interconnector 30 is connected to the interconnector 30. More specifically, a description is given of this structure using the interconnector 30a as an example. The structure characterized by the feature that the cathode-side insulating layer 40a is provided between the interconnector 30a and the cathode catalyst layer 24b is the same as in the first embodiment. On the other hand, a plurality of cathode-side insulating layers 40a′ are formed on the discontinuous region between the interconnector 30a and the cathode catalyst layer 24a. In other words, a plurality of cathode-side insulating layers 40a′ are provided along a side of the cathode catalyst layer 24a on the interconnector 30a side in such a manner that the plurality of cathode-side insulating layers 40a′ are spaced apart from each other. The interconnectors 30a are so formed as to extend in a comb-teeth shape among the adjacent cathode-side insulating layers 40a′. And the interconnector 30a and the cathode catalyst layer 24a are electrically coupled with each other in between the adjacent cathode-side insulating layers 40a′.

As shown in FIG. 9, the cathode-side insulating layers 40a′ are each in contact with inner surface of the cathode housing 50. Openings 70 are formed between the adjacent cathode-side insulating layers 40a′, and the air chambers 60 corresponding to the adjacent single cells communicate with each other through the openings 70.

On the other hand, anode-side insulating layers 42 are provided on the both sides of the connector 30. The anode catalyst layer 26 on one side of the interconnector 30 is formed on a discontinuous region such that the anode catalyst layer 26 disposed on the one side of the interconnector 30 is connected to the interconnector 30. More specifically, a description is given of this structure using the interconnector 30a as an example. The structure characterized by the feature that the anode-side insulating layer 42a is provided between the interconnector 30a and the anode catalyst layer 26a is the same as in the first embodiment. On the other hand, a plurality of anode-side insulating layers 42a′ are formed on the discontinuous region between the interconnector 30a and the anode catalyst layer 26b. In other words, a plurality of anode-side insulating layers 42a′ are provided along a side of the anode catalyst layer 26b on the interconnector 30a side in such a manner that the plurality of anode-side insulating layers 42a′ are spaced apart from each other. The interconnectors 30a are so formed as to extend in a comb-teeth shape among the adjacent anode-side insulating layers 42a′. And the interconnector 30a and the anode catalyst layer 26b are electrically coupled with each other in between the adjacent anode-side insulating layers 42a′.

As shown in FIG. 10, the cathode-side insulating layers 42a′ are each in contact with inner surface of the anode housing 52. Openings 72 are formed between the adjacent anode-side insulating layers 42a′, and the fuel gas chambers 62 corresponding to the adjacent single cells communicate with each other through the openings 72.

According to the above-described fuel cell 10, the diffusivity of air in the air chamber 60 is assured and at the same time the cathode-side insulating layers 40a′ disposed in contact with the cathode housing 50 physically block and prevent the water from staying on between the adjacent single-cell cathodes. As a result, the operation stability or output stability of the fuel cell 10 can be further improved.

Also, the diffusivity of fuel in the fuel gas chamber 62 is assured and at the same time the cathode-side insulating layers 42a′ disposed in contact with the anode housing 52 physically block and prevent the water from staying on between the adjacent single-cell anodes. As a result, the operation stability or output stability of the fuel cell 10 can be further improved.

The present invention is not limited to the above-described embodiments only, and it is understood by those skilled in the art that various modifications such as changes in design may be made based on their knowledge and the embodiments added with such modifications are also within the scope of the present invention.

Though, for example, both the cathode-side insulator 40 and the anode-side insulating layer 42 are provided in each of the above-described embodiments, only either one of them may be provided instead.

Though, in the third embodiment, the cathode-side insulating layer 40a′ and the anode-side insulating layer 42a′ are in contact with the inner surface of the cathode housing 50 and the inner surface of the anode housing 52, respectively, the heights of the cathode-side insulating layer 40a′ and the anode-side insulating layer 42a′ may be equal to the heights of the protruded cathode-side insulating layer 40a and the protruded anode-side insulating layer 42a, respectively. As a result, in addition to the advantageous effect achieved by provision of the cathode-side insulating layers 40a and the anode-side insulating layers 42a, the short-circuiting occurring between the adjacent electrodes can be further suppressed because the cathode-side insulating layers 40a′ and the anode-side insulating layers 42a prevent the water from staying on between the adjacent electrodes.

(First Modification)

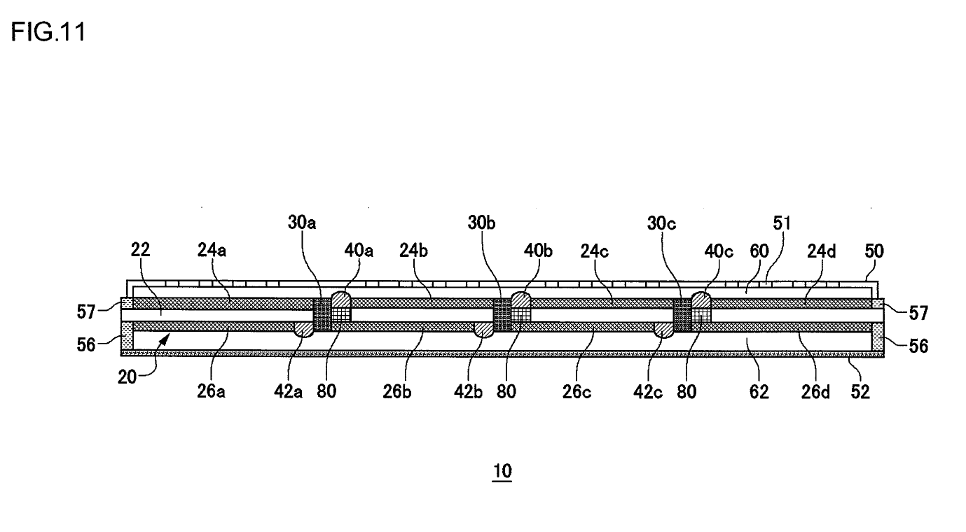

FIG. 11 is a cross-sectional view showing a structure of a fuel cell according to a first modification of the first embodiment. In the fuel cell 10 according to the modifications, the electrolyte membrane 22 is separated for each of the membrane electrode assemblies 20, namely for each single cell, and an insulating substrate 80 is provided between the adjacent electrolyte membranes 22. More specifically, the interconnector 30 and substrate 80 are placed side by side. The material used for the substrate 80 may be a commonly-used plastic resin such as phenol resin, vinyl resin, polyethylene resin, polypropylene resin, polystyrene resin, urea resin or fluororesin.

In the first embodiment, the cathode-side insulating layer 40 and the anode-side insulating layer 42 are provided on the electrolyte membrane 22. In the first modification, the cathode-side insulating layer 40 is provided on the substrate 80 positioned between the interconnector 30 and the cathode catalyst layer 24. The anode-side insulating layer 42 is provided on the substrate 80 positioned between the interconnector 30 and the anode catalyst layer 26.

Similar to the first embodiment, the structure in the fuel cell 10 according to the first modification also suppresses the water from staying on across the adjacent cathode catalyst layers 24 (i.e., between one single-cell cathode catalyst layer 24 and an interconnector 30 connected to the other single-cell cathode catalyst layer 24, in the present modification). As a result, the short-circuiting occurring in the adjacent cathode catalyst layers 24 can be suppressed and consequently the operation stability of the fuel cell can be improved.

Similarly, the structure according to the first modification suppresses the water from staying on across the adjacent anode catalyst layers 26 (i.e., between one single-cell anode catalyst layer 26 and an interconnector 30 connected to the other single-cell anode catalyst layer 26, in the present modification). As a result, the short-circuiting occurring in the adjacent anode catalyst layers 26 can be suppressed and consequently the operation stability of the fuel cell can be improved.

(Second Modification)

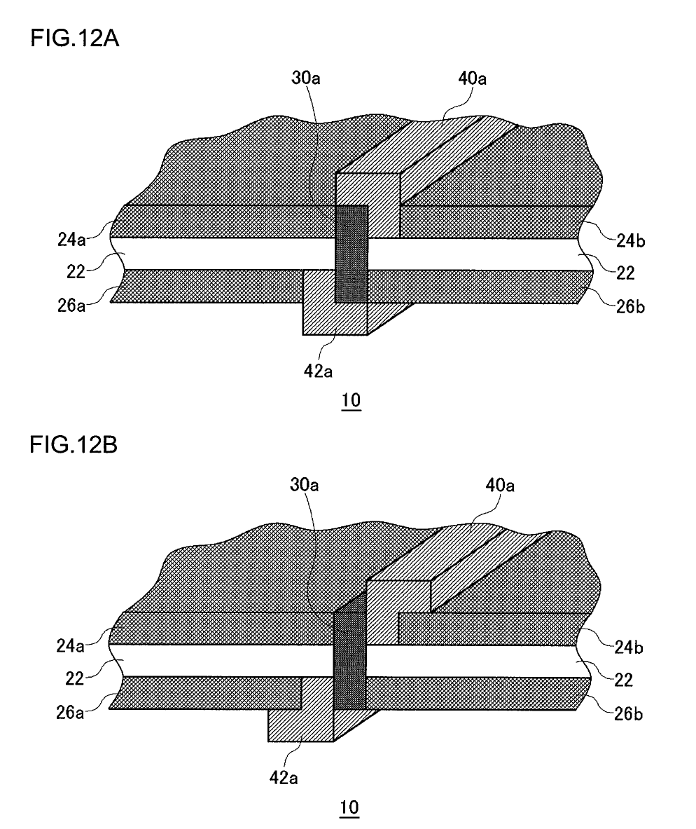

FIG. 12A is a cross-sectional perspective view showing major parts that constitute a fuel cell according to a second modification of the first embodiment. In the second modification, the surface of an interconnector 30 on the cathode side of the fuel cell 10 is covered by the cathode-side insulating layer 40a, and the surface of the cathode-side insulating layer 40a disposed opposite to the electrolyte membrane 22 is protruded, relative to the surface of the adjacent cathode catalyst layers 24a and 24b, above the surface of the interconnector 30 on the cathode side thereof.

On the other hand, the surface of the interconnector 30 on the anode side of the fuel cell 10 is covered by the anode-side insulating layer 42a, and the surface of the anode-side insulating layer 42a disposed opposite to the electrolyte membrane 22 is protruded, relative to the surface of the adjacent anode catalyst layers 26a and 26b, above the surface of the interconnector 30 on the anode side thereof.

According to the second modification, the interconnector 30 is covered with the cathode-side insulating layer 40a in between the cathode catalyst layer 24a and the cathode catalyst layer 24b, which are disposed adjacent to each other, and is therefore not exposed in therebetween. Thus the short-circuiting occurring in the adjacent cathode catalyst layers 24 is further suppressed. Also, the width of a protruded part, relative to the cathode catalyst layer 24, of the cathode-side insulating layer 40a in between the adjacent cathode catalyst layers 24 can be made longer. Hence, the water which may stay on can be further efficiently blocked in between the adjacent cathode catalyst layers 24 and consequently the occurrence of short-circuiting is further suppressed. In Comparative Example 2 described below, the cathode-side insulating layer 40a is not protruded relative to the cathode catalyst layer 24 in between the adjacent cathode catalyst layers 24. Thus, the above-described advantageous effect of blocking the water is much less likely to be realized in Comparative Example 2. The above-described advantageous effects achieved by the structure implemented on the cathode side of the fuel cell 10 can also be achieved on the anode side thereof.

(Third Modification)

FIG. 12B is a cross-sectional perspective view showing major parts that constitute a fuel cell according to a third modification of the first embodiment. In the third modification, a part of the cathode-side insulating layer 40a which is protruded relative to the cathode catalyst layer 24 extends toward the adjacent cathode catalyst layer 24b (a cathode catalyst layer 24 which is in contact with the part thereof on an opposite side of the surface thereof in contact with the interconnector 30a), and the surface of an edge of the cathode catalyst layer 24b being in contact with the cathode-side insulating layer 40a is covered by the cathode-side insulating layer 40a.

On the other hand, a part of the anode-side insulating layer 42a which is protruded relative to the anode catalyst layer 26 extends toward the adjacent anode catalyst layer 26a (an anode catalyst layer 26 which is in contact with the part thereof on an opposite side of the surface thereof in contact with the interconnector 30a), and the surface of an edge of the anode catalyst layer 26a being in contact with the anode-side insulating layer 42a is covered by the anode-side insulating layer 42a.

According to the third modification, the width of a protruded part, relative to the cathode catalyst layer 24, of the cathode-side insulating layer 40a in between the adjacent cathode catalyst layers 24 can be made longer. Hence, the short-circuiting occurring between the adjacent cathode catalyst layers 24 is further suppressed. The advantageous effects achieved by the structure implemented on the cathode side of the fuel cell 10 can also be achieved on the anode side thereof.

### Comparative Example 1

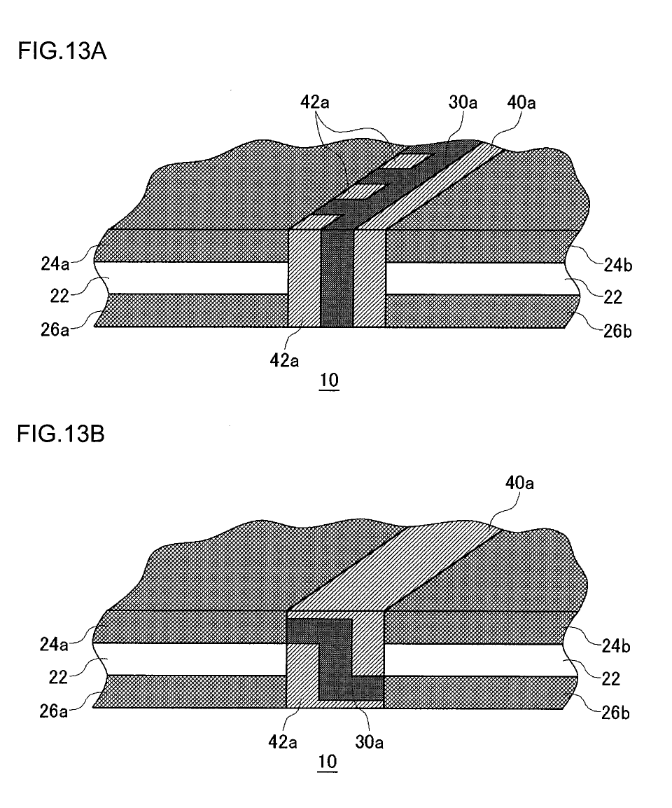

FIG. 13A is a cross-sectional perspective view showing major parts that constitute a fuel cell of Comparative Example 1 in conjunction with the second embodiment. The basic structure of Comparative Example 1 is the same as the structure of the second embodiment. In Comparative Example 1, the protrusions 46 as shown in FIG. 5 are not provided, the protrusions 48 as shown in FIG. 6 are not provided, and the surface of a fuel cell 10 on the cathode side and the surface thereof on the anode side are each flat and each lies in the same plane.

### Comparative Example 2

FIG. 13B is a cross-sectional perspective view showing major parts that constitute a fuel cell of Comparative Example 2 in conjunction with the first modification. Comparative Example 2 shares the same feature as the first modification in that the surface of an interconnector 30 on the cathode side of the fuel cell 10 is covered by a cathode-side insulating layer 40a. However, in Comparative Example 2, the surface of the fuel cell 10 on the cathode side has the flat surface, and the surface of a cathode-side insulating layer 40a disposed opposite to an electrolyte membrane 22 is coplanar with the surfaces of adjacent cathode catalyst layers 24a and 24b.

Also, Comparative Example 2 shares the same feature as the first modification in that the surface of an interconnector 30 on the anode side of the fuel cell 10 is covered by an anode-side insulating layer 42a. However, in Comparative Example 2, the surface of the fuel cell 10 on the anode side has the flat surface, and the surface of an anode-side insulating layer 42a disposed opposite to the electrolyte membrane 22 is coplanar with the surfaces of adjacent anode catalyst layers 26a and 26b.

Accordingly, the surface of part of an interconnector 30a coupled with the cathode catalyst layer 24a is recessed against the surface of the cathode catalyst layer 24a toward an electrolyte membrane 22 side by the thickness of the cathode-side insulating layer 40a being in contact with the cathode catalyst layer 24a. Also, the surface of part of the interconnector 30a coupled with the anode catalyst layer 26b is recessed against the surface of the anode catalyst layer 26b toward the electrolyte membrane 22 side by the thickness of the anode-side insulating layer 42a being in contact with the anode catalyst layer 26b.

Note that the thickness of part of the cathode-side insulating layer 40a in contact with the cathode catalyst layer 24a and the thickness of part of the anode-side insulating layer 42a in contact with the anode catalyst layer 26b may each be set to a value greater than or equal to the thickness which can be formed by coating.

While the preferred embodiments of the present invention and their modifications have been described using specific terms, such description is for illustrative purposes only, and it is to be understood that changes and variations may further be made without departing from the spirit or scope of the appended claims.

What is claimed is:

1. A fuel cell, comprising:
a plurality of single cells, disposed in a planar arrangement, each single cell including an electrolyte membrane containing an ionomer, an anode provided on one face of the electrolyte membrane and a cathode provided on the other face of the electrolyte membrane; and
an insulating layer provided between adjacent electrodes in at least one of adjacent anodes and adjacent cathodes, for the each of adjacent single cells in the plurality of single cells,
wherein said insulating layer is protruded relative to the surface of the adjacent electrodes.

2. A fuel cell according to claim 1, wherein said insulating layer is water-repellent.

3. A fuel cell according to claim 1, further comprising a plate-like member which forms a reaction gas chamber facing the electrodes,
wherein at least part of surface, of said insulating layer, opposite to the electrolyte membrane is in contact with said plate-like member.

4. A fuel cell according to claim 2, further comprising a plate-like member which forms a reaction gas chamber facing the electrodes,
wherein at least part of surface of said insulating layer on either face of the electrolyte membrane is in contact with said plate-like member.

5. A fuel cell according to claim 1, further comprising an electrical connecting member, disposed along the adjacent electrodes, configured to connect adjacent single cells in series,
wherein said insulating layer is provided on the both sides of said electrical connecting member, and
wherein said insulating layer on one side of said electrical connecting member is formed on a discontinuous region such that an electrode disposed on the one side of said electrical connecting member is connected to the electrical member.

6. A fuel cell according to claim 2, further comprising an electrical connecting member, disposed along the adjacent electrodes, configured to connect adjacent single cells in series,
wherein said insulating layer is provided on the both sides of said electrical connecting member, and
wherein said insulating layer on one side of said electrical connecting member is formed on a discontinuous region such that an electrode disposed on the one side of said electrical connecting member is connected to the electrical member.

7. A fuel cell according to claim 4, further comprising an electrical connecting member, disposed along the adjacent electrodes, configured to connect adjacent single cells in series,
wherein said insulating layer is provided on the both sides of said electrical connecting member, and
wherein said insulating layer on one side of said electrical connecting member is formed on a discontinuous region such that an electrode disposed on the one side of said electrical connecting member is connected to the electrical member, and
said insulating layer formed on the discontinuous region is in contact with said plate-like member.
